(19) United States
(12) Patent Application Publication
(10) Pub. No.: US 2010/0005335 A1
(43) Pub. Date: Jan. 7, 2010

(54) MICROPROCESSOR INTERFACE WITH DYNAMIC SEGMENT SPARING AND REPAIR

(75) Inventors: Frank D. Ferraiolo, New Windsor, NY (US); Daniel M. Dreps, Georgetown, TX (US); Kevin C. Gower, LaGrangeville, NY (US); Robert J. Reese, Austin, TX (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/165,858

(22) Filed: Jul. 1, 2008

(51) Int. Cl. G06F 11/00; G06F 13/40

(52) U.S. Cl. 714/3; 710/305; 714/E11.02

(57) ABSTRACT

A processing device, system, method, and design structure for providing a microprocessor interface with dynamic segment sparing and repair. The processing device includes drive-side switching logic including driver multiplexers to select driver data for transmitting on link segments of a bus, and receive-side switching logic including receiver multiplexers to select received data from the link segments of the bus. The bus includes multiple data link segments, a clock link segment, and at least two spare link segments selectable by the drive-side switching logic and the receive-side switching logic to replace one or more of the data link segments and the clock link segment.

### BACKGROUND

This invention relates generally to computer system communications, and more particularly to providing a microprocessor interface with dynamic segment sparing and repair.

Overall computer system performance is affected by each of the key elements of the computer structure, including the performance/structure of the processor(s), any memory cache(s), the input/output (I/O) subsystem(s), the efficiency of the memory control function(s), the main memory device(s), and the type and structure of the interconnect interface(s).

Extensive research and development efforts are invested by the industry, on an ongoing basis, to create improved and/or innovative solutions to maximizing overall computer system performance and density by improving the system/subsystem design and/or structure. High-availability systems present further challenges as related to overall system reliability due to customer expectations that new computer systems will markedly surpass existing systems in regard to mean-time-between-failure (MTBF), in addition to offering additional functions, increased performance, increased storage, lower operating costs, etc. Other frequent customer requirements further exacerbate the computer system design challenges, and include such items as ease of upgrade and reduced system environmental impact (such as space, power and cooling).

### SUMMARY

An exemplary embodiment is a processing device that includes drive-side switching logic including driver multiplexers to select driver data for transmitting on link segments of a bus, and receive-side switching logic including receiver multiplexers to select received data from the link segments of the bus. The bus includes multiple data link segments, a clock link segment, and at least two spare link segments selectable by the drive-side switching logic and the receive-side switching logic to replace one or more of the data link segments and the clock link segment.

Another exemplary embodiment is a processing system with a first processing device including drive-side switching logic that includes driver multiplexers to select driver data for transmitting on link segments of a bus, and a second processing device in communication with the first processing device via the bus. The second processing device includes receive-side switching logic that includes receiver multiplexers to select received data from the link segments of the bus. The bus includes multiple data link segments, a clock link segment, and at least two spare link segments selectable by the drive-side switching logic and the receive-side switching logic to replace one or more of the data link segments and the clock link segment.

A further exemplary embodiment is a method for providing a microprocessor interface with dynamic segment sparing and repair. The method includes determining that an error exists on a link segment of a microprocessor interconnect bus between a driver and a receiver in a processing system, where the microprocessor interconnect bus includes multiple data link segments, a clock link segment, and at least two spare link segments. The method further includes selecting driver data via driver multiplexers at the driver to transmit on selected link segments of the microprocessor interconnect bus, switching out one or more of the data link segments and the clock link segment. The method additionally includes selecting received data from the bus via receiver multiplexers at the receiver corresponding to the selected link segments.

An additional exemplary embodiment is a design structure tangibly embodied in a machine-readable medium for designing, manufacturing, or testing an integrated circuit. The design structure includes drive-side switching logic including driver multiplexers to select driver data for transmitting on link segments of a microprocessor interconnect bus, and receive-side switching logic including receiver multiplexers to select received data from the link segments of the microprocessor interconnect bus. The microprocessor interconnect bus includes multiple data link segments, a clock link segment, and at least two spare link segments selectable by the drive-side switching logic and the receive-side switching logic to replace one or more of the data link segments and the clock link segment.

Other systems, methods, apparatuses, design structures and/or computer program products according to embodiments will be or become apparent to one with skill in the art upon review of the following drawings and detailed description. It is intended that all such additional systems, methods, apparatuses, design structures and/or computer program products be included within this description, be within the scope of the present invention, and be protected by the accompanying claims.

### BRIEF DESCRIPTION OF THE SEVERAL VIEWS OF THE DRAWINGS

Referring now to the drawings wherein like elements are numbered alike in the several FIGURES:

FIG. 1 depicts a multi-chip module (MCM) with multiple microprocessor cores communicating via busses with dynamic segment sparing and repair that may be implemented by exemplary embodiments;

FIG. 2 depicts a processing system with multiple processing devices in communication via busses with dynamic segment sparing and repair that may be implemented by exemplary embodiments;

FIG. 3 depicts an example of drive-side and receive-side switching logic that may be implemented by exemplary embodiments;

FIG. 4 depicts data assignments for bus lanes that may be implemented by exemplary embodiments;

FIG. 5 depicts data and clock repair logic that may be implemented by exemplary embodiments;

FIG. 6 depicts examples of multiple processing systems in communication via busses with dynamic segment sparing and repair that may be implemented by exemplary embodiments;

FIG. 7 depicts an exemplary process for providing a microprocessor interface with dynamic segment sparing and repair that may be implemented by exemplary embodiments; and

FIG. 8 is a flow diagram of a design process used in semiconductor design, manufacture, and/or test.

### DETAILED DESCRIPTION

As large computer systems become increasing more complex, the number of interconnections between integrated circuits or chips in the computer systems also increases. The number of interconnections, for example between a microprocessor to memory, the microprocessor to other microprocessors, the microprocessors to cache or I/O chips, are increasing to the point where today's large computer systems may have tens of thousands of interconnections between chips within the system. These signals can be carried on metal wires from a transmit chip through a chip carrier, to cards and/or boards, possibly through several connectors to a receiver chip on a second carrier. All of the interconnections and signals should be manufactured and remain defect free over the life of the product; otherwise, a system failure can occur. A single failure or latent defect typically impacts part or all of the computer system's operation.

At component manufacturing test, if some amount of defects can be tolerated without requiring the component to be scrapped, a significant amount of scrap cost can be reduced. In an exemplary embodiment, if a defect does occur over time (during the life of the product), the computer system diagnoses the failure and dynamically reconfigures signals around the defect to maintain operation without loss of performance or function. This may apply to any chip-to-chip interface (i.e., a bus) within a computer or a computer system that sends data, control, or address information to communicate, such as processing devices in a processing system. Dynamic segment sparing and repair of bus segments, such as segments of a microprocessor interconnect bus are provided. Spare segments that can rapidly replace either a failed data signal or a failed clock further enhance system reliability in accommodating failed bus segments.

In an exemplary embodiment, bus interconnections between physical devices, such as processing devices, can repair themselves with multiple failures present (including manufacturing defects) or even a defect in a clock segment of the bus. This allows multiple defects to exist while enabling the system to maintain normal operation. Applying dynamic segment sparing to a processing system can improve the reliability of the processing system as failures in different segments between devices are accommodated, including data link segments and clock link segments.

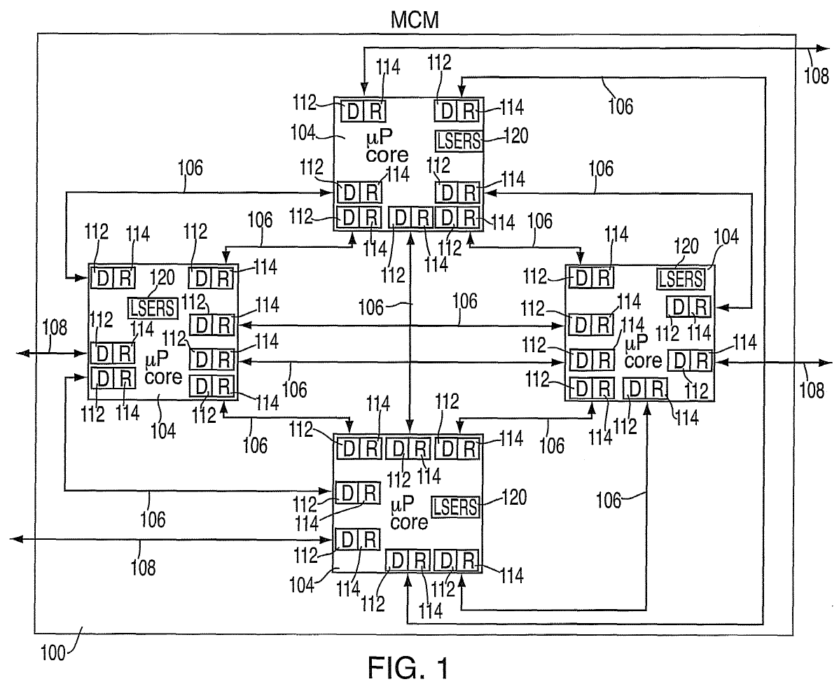

Turning now to FIG. 1, an example of a multi-chip module (MCM) 100 that includes multiple microprocessor cores 104 using dynamic segment sparing and repair is depicted. In an exemplary embodiment, the MCM 100 is a single package, such as ceramic module. The microprocessor cores 104 can be separate chips aggregated together to form the MCM 100 or functional modules integrated in the MCM 100. Each of the microprocessor cores 104 includes processing circuitry to read and execute instructions to perform logic functions. The MCM 100 may be incorporated in a host processing system and interfaced to other devices and subsystems as part of a larger processing system. The microprocessor cores 104 can communicate with each other via microprocessor interconnect busses 106. To maximize communication bandwidth and increase reliability and availability of inter-processor communication, there can be redundant microprocessor interconnect busses 106 interconnecting the microprocessor cores 104. In an exemplary embodiment, each microprocessor core 104 is coupled to the other microprocessor cores 104 in the MCM 100 with at least a pair of microprocessor interconnect busses 106.

The microprocessor cores 104 include drive-side switching logic (DSL) 112 and receive-side switching logic (RSL) 114 to control the assignment of specific signals to segments of the microprocessor interconnect busses 106. Each microprocessor interconnect bus 106 may includes connections, also referred to as link segments or bit lanes. The microprocessor interconnect busses 106 may include single-ended segments, differential-ended segments, or a combination thereof The segments/lanes can be assigned to dedicated signal types, such as data, commands, addresses, and clocks, or segments/lanes can have mixed uses. The segments/lanes may be bi-directional or uni-directional. In an exemplary embodiment, the microprocessor interconnect busses 106 each include spare link segments that can be used to dynamically repair a failed link segment by switching signal assignments such that one or more of the spare link segments become active. Link segment error registers (LSERs) 120 in the microprocessor cores 104 can be used to identify link segment errors and make spare lane selections in the DSL 112 and RSL 114. The DSL 112 can drive signals, while the RSL 114 receives signals. Each microprocessor core 104 may include multiple DSL 112/RSL 114 pairs for driving and receiving communications on the microprocessor interconnect busses 106, as well as other busses, such as external busses 108.

Although only a single MCM 100 is shown in FIG. 1 with four interconnected microprocessor cores 104, the scope of the invention is not so limited, as there may be any number of microprocessor cores 104 interconnected via microprocessor interconnect busses 106 within the MCM 100 and multiple MCMs interconnected via the external busses 108. Thus, the external busses 108 may be functionally equivalent to the microprocessor interconnect busses 106, but may vary in the number of segments/bit lanes. The external busses 108 can communicate with a variety of interfaces, such as memory, I/O, or other microprocessor cores 104 that can be integrated in other MCMs 100 or in single processing core devices. Moreover, any number of segments/bit lanes can be included in each microprocessor interconnect bus 106, with a different number segments/bit lanes driven in each direction. For example, for a given DSL 112/RSL 114 pair in one of the interconnected microprocessor cores 104, the microprocessor interconnect bus 106 may include 13 bit lanes, 2 spare lanes and a clock lane driven from the DSL 112, but 20 bit lanes, 2 spare lanes and a clock lane received at the RSL 114, with a corresponding interconnected microprocessor core 104 having the opposite configuration interconnected via the microprocessor interconnect bus 106.

In an exemplary embodiment, initially, all lanes are powered-on, tested and aligned during initialization, but defective lanes and unneeded (unused) spares are deactivated during normal run-time operation. System control software, such as firmware can be used to determine transitions between testing bit lanes and selecting bit lanes for repair, which may be performed as part of a system initialization and configuration process prior to commencing normal operation.

When a hard failure in any link segment is detected, a spare link segment is activated and replaces the defective link segment in the microprocessor interconnect bus 106. The system communication format, error detection and protocols may be the same before and after spare lane invocation. Each segment of the microprocessor interconnect busses 106 can independently deploy their dedicated spares on a per link basis. This maximizes the ability to survive multiple failures in different link segments. The drive-side switching and receive-side switching can be performed independently in each direction on the microprocessor interconnect busses 106.

In an exemplary embodiment, the spare lanes are tested and aligned during initialization and deactivated during normal run-time operation. Sparing (switching out a failed link segment) can be performed during initialization based on previous lane failure data. Spare link segments can also be selected dynamically by hardware during run-time as part of error recovery. The error recovery may include re-initialization and repair of links by switching out a failed link. System control software can load the LSERs 120 to control selection of signals for each link segment.

A failed link can be detected using a variety of techniques. For example, during initialization one or more patterns can be sent on the link segments to verify that received patterns match the transmitted patterns. During normal operation, an error correcting code (ECC) or other error detection and/or correction technique can be used to detect a failure. Once a failed link is detected, the MCM 100 may initiate one or more retry operations to confirm the failure, and then attempt to isolate the specific failed link segment. Repair and re-initialization operations can be performed if any retry operation fails. A failed microprocessor core 104 may also indirectly initiate repair and re-initialization in response to detecting a persistent error that is not corrected via a retry.

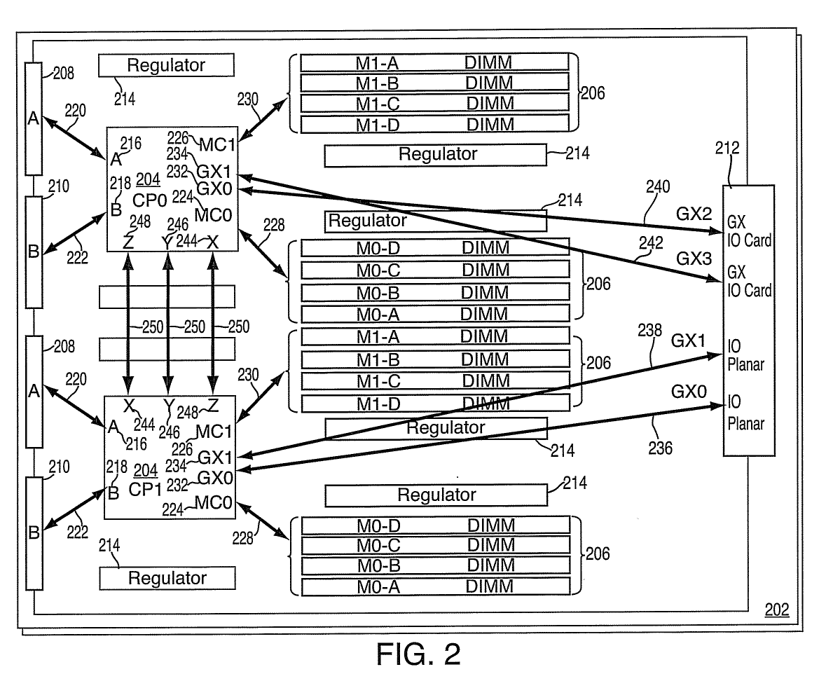

FIG. 2 depicts a processing system 202 with multiple processing devices 204 in communication via busses with dynamic segment sparing and repair that may be implemented by exemplary embodiments. The processing devices 204 may be embodiments of the MCM 100 with additional bus interfaces. In an alternate embodiment, the processing devices 204 are single core processing devices (e.g., containing one microprocessor core 104 per processing device 204) with multiple bus interfaces capable of executing instructions. The processing system 202 also includes multiple groups of memory modules 206. The memory modules 206 may be dual-inline memory modules (DIMMs) of dynamic random access memory (DRAM), such as double-data rate 3 (DDR3) DRAMs. The processing system 202 can also include multiple interfaces to other processing systems 202, such as system interfaces A 208 and B 210. The processing system 202 may further interface to input/output (I/O) devices via I/O interface 212. Additionally, the processing system 202 can include multiple voltage regulators 214. The voltage regulators 214 may be distributed across the processing system 202 to minimize noise and parasitic effects that can accompany longer trace lengths. Distributing the voltage regulators 214 can also increase reliability, as a single voltage regulator 214 failure does not impact all of the devices in the processing system 202.

In an exemplary embodiment, each processing device 204 includes multiple bus interfaces. Bus interfaces A 216 and B 218 can drive commands and data on busses 220 and 222 to system interfaces A 208 and B 210 respectively. The bus interfaces A 216 and B 218 can both include DSL 112/RSL 114 pairs as described in FIG. 1. The processing devices 204 may also include memory control bus interfaces MC0 224 and MC1 226 to communicate with the memory modules 206 via memory busses 228 and 230 respectively. The memory control bus interfaces MC0 224 and MC1 226 can both include DSL 112/RSL 114 pairs as described in FIG. 1. The processing devices 204 can also include I/O bus interfaces GX0 232 and GX1 234 to communicate with I/O card and planar interfaces of the I/O interface 212 via busses 236, 238, 240, and 242. The I/O bus interfaces GX0 232 and GX1 234 may both include DSL 112/RSL 114 pairs as described in FIG. 1. There can also be multiple cross-processor communication interfaces to communicate between the processing devices 204 of the processing system 202. Processor interconnect interfaces X 244, Y 246, and Z 248 may be used to communicate between the processing devices 204 via busses 250. In an exemplary embodiment, the processor interconnect interfaces X 244, Y 246, and Z 248 include DSL 112/RSL 114 pairs as described in FIG. 1 for dynamic segment sparing and repair. Each of the busses 220, 222, 228, 230,240, 242, and 250 may be functionally equivalent to the microprocessor interconnect bus 106 of FIG. 1 but vary in width, data rate, and physical characteristics. Thus, a variety of bus interfaces in the processing system 202 may support dynamic segment sparing and repair with DSL 112/RSL 114 pairs at both ends of the respective busses.

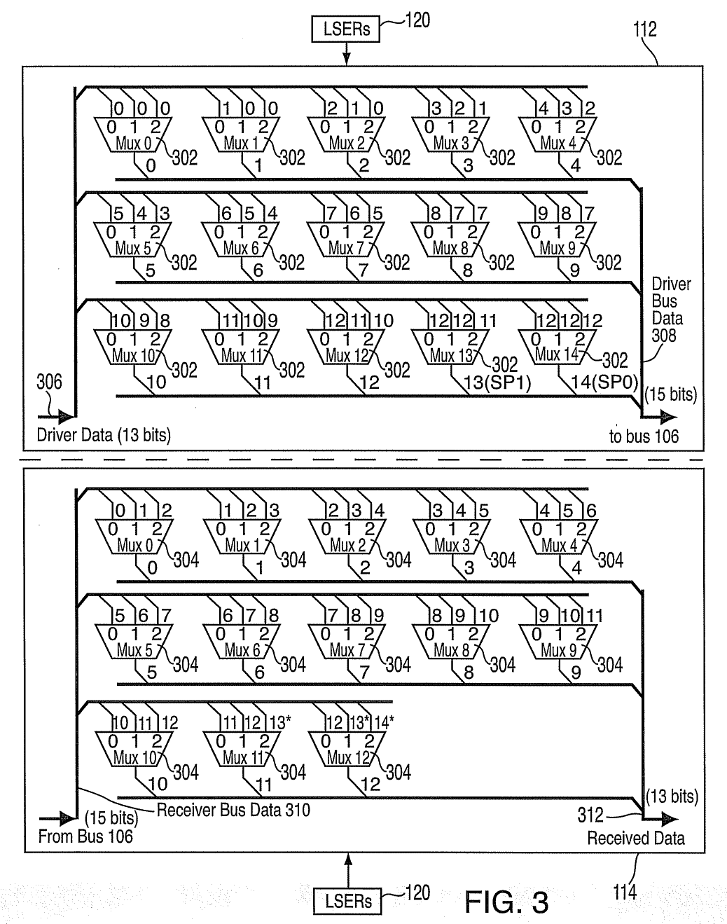

Referring to FIG. 3, greater detail of the DSL 112 and the RSL 114 of FIG. 1 is depicted. For purposes of explanation the DSL 112 and the RSL 114 of FIG. 3 are assumed to be in communication from the DSL 112 to the RSL 114, e.g., DSL 112 of one microprocessor core 104 coupled to the RSL 114 of another microprocessor core 104 via link segments of bus 106. In an exemplary embodiment, the DSL 112 includes multiple 3-to-1 driver multiplexers (muxes) 302, and the RSL 114 includes multiple 3-to-1 receiver muxes 304. The driver muxes 302 control switching of specific bits of driver data 306 to driver bus data 308, which is output on bus 106. Similarly, the receiver muxes 304 control switching of specific receiver bus data 310 received via the bus 106 and output the results as received data 312. In the example depicted in FIG. 3, 13 bits of driver data 306 are routed in groups of three to 15 driver muxes 302. The output of the 15 driver muxes 302 includes 2 spare signals that may be a redundant version of one or two bits of the driver data 306. The receiver bus data 310 includes 15 bits that correspond to the driver bus data 308 when no errors are present. The receiver muxes 304 select 13 of the 15 bits of the receiver bus data 310 to output as 13 bits of received data 312. The LSERs 120 interfaced to the DSL 112 and the RSL 114 control selection of specific bits at each of the driver muxes 302 and the receiver muxes 304 respectively.

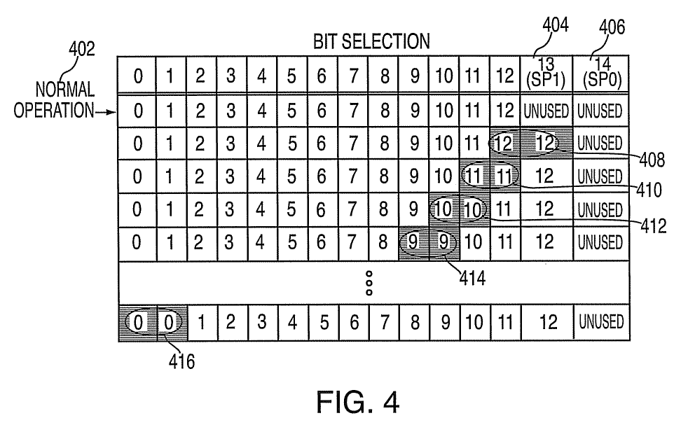

Initially, in the absence of any defects, the control signals to the driver muxes 302 and the receiver muxes 304 are set to all zero, selecting the 0 inputs. Referring to FIG. 4, the first row 402 indicates bit selections for normal operation. In this example, spare segments sp1 404 and sp0 406 are powered down (unused) to save power. Subsequent rows depict examples of bit pairs, where one link segment is considered to be bad, resulting in a shift to steer the data from the defective link segment to a functional link segment. A similar mux control vector on the receive side selects all zero inputs to the receiver muxes 304. For example, if bit 12 is determined to be bad then the mux controls in the LSERs 120 are set to zeros on the driver muxes 302 for muxes 0 through 11 and mux 13 is set to a 1. This action steers lane 12 data down link segment 13 of the bus 106, which could be a downstream link segment 116 or an upstream link segment 118. On the receive side, muxes 0-11 of the receiver muxes 304 remain unchanged (set to zero) and bit 12 (mux 12 of the receiver muxes 304) is set to a 1 to steer link segment 13 on the bus 106 to bit 12 of the received data 312. The shift in position is depicted in bit selection pair 408.

Similar to the case with bit 12, if bit (link segment 11 of the lane) 11 is determined to be defective, then the mux controls are set to zeros on the driver muxes 302 for muxes 0-10 and mux 12 and mux 13 are set to a 1. This action steers link segment 11 data down link segment 12 and steers link segment 12 data down link segment 13 of the bus 106. On the receive side, muxes 0-10 of the receiver muxes 304 remain unchanged (set to zero) and bit 11 (mux 11 of the receiver muxes 304) is set to a 1 to steer link segment 12 on the bus 106 to bit 11 and similarly mux 12 of the receiver muxes 304 is set to a 1 to steer bit 13 to link segment 12. The shift in position is depicted in bit selection pair 410. This process can performed using any bit pairs, e.g., bit pairs 412, 414, down to bit pair 416.

In a similar way any bad or defective link segment can be steered to the adjacent link segment. If both link segments 11 and 12 are defective, then both spares sp1 404 and sp0 406 are employed. In this case, mux 14 is set to a logical 2, mux 13 to a logical 1, and muxes 0-10 are kept at their normal logic zero on the driver muxes 302. This action steers bit 12 down link segment 14 and bit 11 down link segment 13. On the receiver muxes 304, mux 12 is set to a logical 2, mux 11 is set to a logical 1, and all other muxes are set to a logical 0. This action steers bit 11 and bit 12 from link segments 13 and 14 back to their correct bit positions. Hence, two defects can be corrected. These two defect may have occurred at any point in the lifecycle of the system, e.g., during manufacturing or normal operation.

In an exemplary embodiment, the mux controls (LSERs 120) are typically not changed during normal operation since altering the signal paths in real time requires precise timing and coordination between both ends of the link when operating at high speed. A bad link segment may be identified prior to functional operation, during an initialization or power on procedure where specific patterns are transmitted down each lane and checked on the received side for proper operation. If during the initialization process a defective link segment is identified, it can be spared out using one of the available spares. A bad link segment may also be detected during functional operation. Using an ECC, for example, the bad link segment can be spared out in a relatively short period of time, avoiding full re-initialization, to allow the defective signal (or signals) to be re-routed and spare bits utilized. The bus 106 can then be brought back online, and functional operation returns. In an alternate exemplary embodiment, link errors are detected in functional operation with no isolation mechanism present, and hence the link is prompted to reinitialize. It is during the reinitialization process, where predetermined patterns are sent down each link segment and the link segments are interrogated as good or bad, that the defective link segment may be discovered and repaired.

Although FIGS. 3 and 4 have been described in reference to a particular number of segments/lanes in reference to the bus 106 of FIG. 1, the scope of the invention is not so limited. The number of connections within a grouping can be larger or smaller and/or may depend on the physical characteristics of the device (e.g., MCM 100 and/or processing device 204 of FIG. 2) or the bus 106 (or busses of FIG. 2, such as busses 220, 222, 228, 230, 236-242, and/or 250). Further each bus can be made up of one large group or multiple smaller groups.

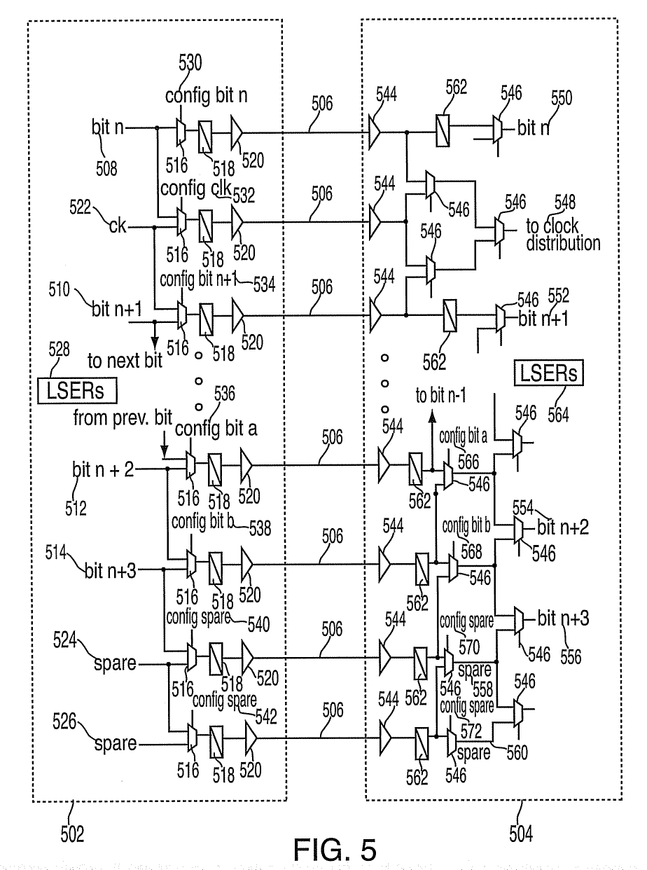

Referring to FIG. 5, if any of the link segments are assigned as a bus clock then the bus clock can also be repaired. FIG. 5 depicts DSL 502 in communication with RSM 504 via link segments 506. The DSL 502 drives data bits, such as bit n 508, bit n+1 510, bit n+2 512, bit n+3 514, etc., through driver muxes 516, driver latches 518, and line drivers 520 to the link segments 506. Each of the driver muxes 516 can select from multiple signals to drive, as one of the data bits 508-514, a clock 522, or one of the spares 524 and 526. The selection of signals controlling the driver muxes 516 is driven by configuration signals of the LSERs 528 (e.g., config bit n 530, config clk 532, config bit n+1 534, config bit a 536, config bit b 538, config spare 540 and config spare 542).

On the receive side at RSL 504, the link segments 506 are coupled to receiver circuits 544, which may amplify and otherwise condition the signals received. To support clock sparing, link segments 506 that can carry a clock signal may be driven into receiver muxes 546 without latching and prior to clock distribution 548. This avoids duplication of the clock distribution 548, which distributes the received clock, for example in the MCM 100 or in processing devices 204. Detection of a defective clock can be performed using similar approaches as for bad data link segments. For example, during initialization the clock can be tested looking across multiple data lanes for global functionality or be redriven and sent to another chip (e.g., a processing device 204) with a known good clock to be tested. During normal operation multiple bad bits across the bus may indicate a clock problem and prompt a clock repair. As part of the initialization, the clock may be swapped out or tested. A defective clock may be shifted directly to a spare link segment or can be shifted to an adjacent link segment with subsequent data link segments shifted to utilize one of the spare link segments. For data or spare bits, such as bit n 550, bit n+1 552, bit n+2 554, bit n+3 556 and spares 558 and 560, received signals on the receiver circuits 544 are buffered using receiver latches 562 prior to the receiver muxes 546. The selection of signals controlling the receiver muxes 546 is driven by configuration signals of LSERs 564 (e.g., config bit a 566, config bit b 568, config spare 570 and config spare 572). While the receiver muxes 546 are depicted as 2 input muxes, they are effectively made into higher order muxes by staging multiple receiver muxes 546.

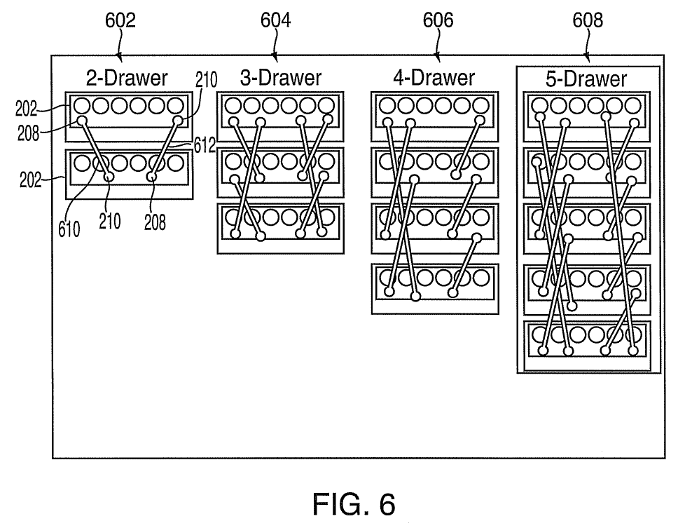

FIG. 6 depicts examples of multiple processing systems 202 in communication via busses with dynamic segment sparing and repair that may be implemented by exemplary embodiments. In FIG. 6, a variety of system configurations are depicted as 2-drawer 602, 3-drawer 604, 4-drawer 606, and 5-drawer 608, where each drawer contains a processing system 202. As multiple processing systems 202 are interconnected, a greater amount of processing bandwidth is achieved. The system interfaces A 208 and B 210 support connectivity between the processing systems 202. Using multiple busses, such as busses 610 and 612 with multiple link segments/bit lanes bundled in flexible cables, enhanced reliability can be achieved for each of the system configurations, 2-drawer 602, 3-drawer 604, 4-drawer 606, and 5-drawer 608. Redundant busses provide enhanced reliability for bus-wide issues, while problems with individual link segments/bit lanes of the busses, such as busses 610 and 612, can be detected via dynamic segment sparing and repair.

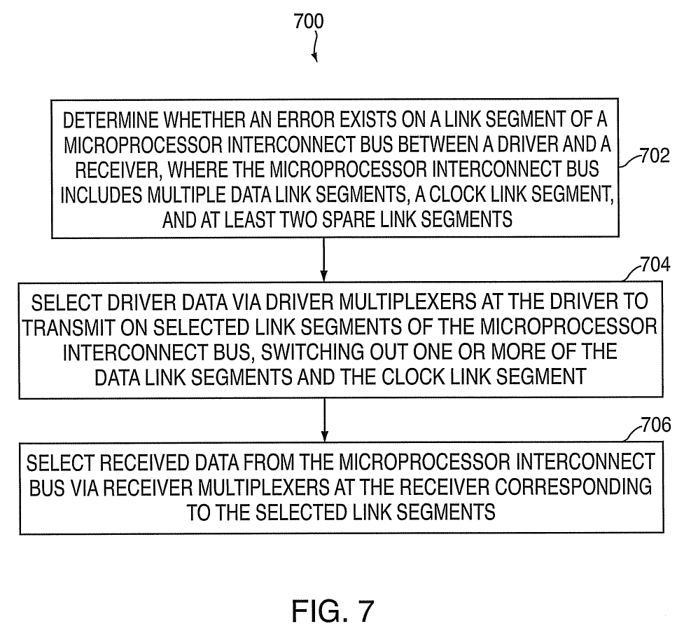

FIG. 7 depicts a process 700 for providing dynamic segment sparing and repair in a processing system that may be implemented as described in reference to FIGS. 1-6. For example, the process 700 may be implemented in the microprocessor cores 104 of FIG. 1 and/or the processing devices 204 of FIG. 2. For purposes of explanation, the process 700 is described in reference to the MCM 100 of FIG. 1. At block 702, one of the microprocessor cores 104 determines whether an error exists on a link segment of the microprocessor interconnect bus 106 between a driver (DSL 112) and a receiver (RSL 114) in the MCM 100, where the microprocessor interconnect bus 106 includes multiple data link segments, a clock link segment, and at least two spare link segments. Link segments, such as link segments 506 of FIG. 5, may be data link segments for communicating data bits (e.g., bit n 508, bit n+1 510, etc.), a clock link segment for sending a bus clock (e.g., clock 522), or spare link segments (e.g., spares 524 and 526) to replace defective data or clock link segments.

At block 704, the DSL 112 selects driver data 306 of FIG. 3 via driver muxes 302 to transmit on selected link segments of the microprocessor interconnect bus 106, switching out one or more of the data link segments and the clock link segment. The LSERs 120 can be used to assign signals to specific link segments. Control logic may set and clear values in the LSERs 120, as well as control transitions through initialization and re-initialization.

At block 706, the RSL 114 selects received data 312 from the microprocessor interconnect bus 106 via receiver muxes 304 corresponding to the selected link segments. The LSERs 120 can be used to select specific link segments. The driver muxes 302 and the receiver muxes 304 may be configured upon initialization in response to a pattern transmitted on the microprocessor interconnect bus 106 to detect one or more defective link segments with respect to a second processing device, such as another microprocessor core 104 or processing device 204. The microprocessor interconnect bus 106 can also be used to connect the microprocessor core 104 with memory subsystems (e.g., memory modules 206 or cache memory (not depicted)), or I/O interface 212. The driver muxes 302 and the receiver muxes 304 can be configured to switch out a defective link segment upon detecting the defective link segment during a high-speed mode of bus operation when the defective link segment is identified during the high-speed mode, providing rapid recovery. However, if only a general communication error is identified without isolating the defect to a specific link segment during normal operation, then the initialization can be repeated to isolate the defective link segment using a pattern transmitted on the microprocessor interconnect bus 106. To conserver power, unused link segments can be depowered, including a defective link segment, once identified. Unused link segments can also be used for other functions, such as sending out-of-band communication and/or test signals.

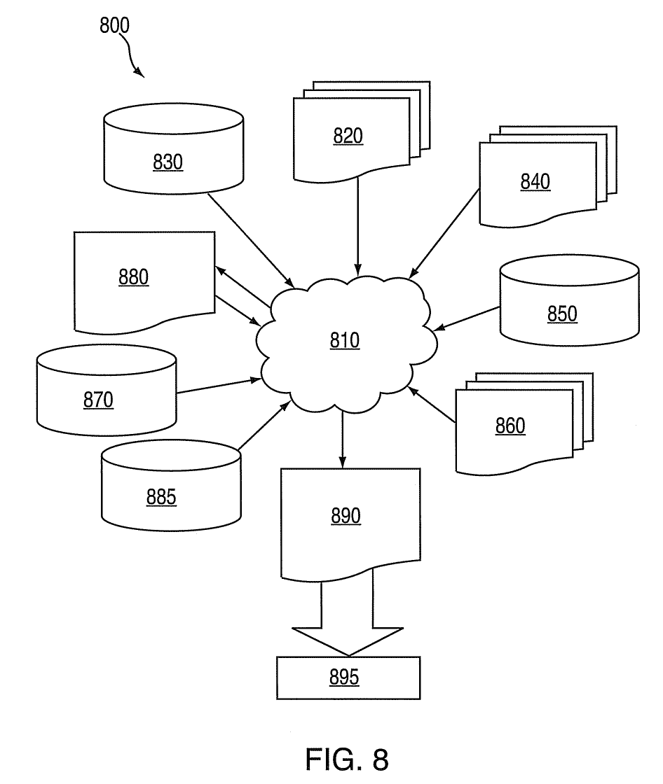

FIG. 8 illustrates multiple such design structures including an input design structure 820 that is preferably processed by a design process 810. Design structure 820 may be a logical simulation design structure generated and processed by design process 810 to produce a logically equivalent functional representation of a hardware device. Design structure 820 may also or alternatively comprise data and/or program instructions that when processed by design process 810, generate a functional representation of the physical structure of a hardware device. Whether representing functional and/or structural design features, design structure 820 may be generated using electronic computer-aided design (ECAD) such as implemented by a core developer/designer. When encoded on a machine-readable data transmission, gate array, or storage medium, design structure 820 may be accessed and processed by one or more hardware and/or software modules within design process 810 to simulate or otherwise functionally represent an electronic component, circuit, electronic or logic module, apparatus, device, or system such as those shown in FIGS. 1-7. As such, design structure 820 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 810 preferably employs and incorporates hardware and/or software modules for synthesizing, translating, or otherwise processing a design/simulation functional equivalent of the components, circuits, devices, or logic structures shown in FIGS. 1-7 to generate a netlist 880 which may contain design structures such as design structure 820. Netlist 880 may comprise, for example, compiled or otherwise processed data structures representing a list of wires, discrete components, logic gates, control circuits, I/O devices, models, etc. that describes the connections to other elements and circuits in an integrated circuit design. Netlist 880 may be synthesized using an iterative process in which netlist 880 is resynthesized one or more times depending on design specifications and parameters for the device. As with other design structure types described herein, netlist 880 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 810 may include hardware and software modules for processing a variety of input data structure types including netlist 880. Such data structure types may reside, for example, within library elements 830 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 840, characterization data 850, verification data 860, design rules 870, and test data files 885 which may include input test patterns, output test results, and other testing information. Design process 810 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 810 without deviating from the scope and spirit of the invention. Design process 810 may also include modules for performing standard circuit design processes such as timing analysis, verification, design rule checking, place and route operations, etc.

Design process 810 employs and incorporates logic and physical design tools such as HDL compilers and simulation model build tools to process design structure 820 together with some or all of the depicted supporting data structures along with any additional mechanical design or data (if applicable), to generate a second design structure 890. Design structure 890 resides on a storage medium or programmable gate array in a data format used for the exchange of data of mechanical devices and structures (e.g. information stored in a IGES, DXF, Parasolid XT, JT, DRG, or any other suitable format for storing or rendering such mechanical design structures). Similar to design structure 820, design structure 890 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIGS. 1-7. In one embodiment, design structure 890 may comprise a compiled, executable HDL simulation model that functionally simulates the devices shown in FIGS. 1-7.

Design structure 890 may also employ a data format used for the exchange of layout data of integrated circuits and/or symbolic data format (e.g. information stored in a GDSII (GDS2), GL1, OASIS, map files, or any other suitable format for storing such design data structures). Design structure 890 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 1-7. Design structure 890 may then proceed to a stage 895 where, for example, design structure 890: proceeds to tape-out, is released to manufacturing, is released to a mask house, is sent to another design house, is sent back to the customer, etc.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The capabilities of the present invention can be implemented in software, firmware, hardware or some combination thereof.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Module support devices (such as buffers, hubs, hub logic chips, registers, PLL's, DLL's, non-volatile memory, etc) may be comprised of multiple separate chips and/or components, may be combined as multiple separate chips onto one or more substrates, may be combined onto a single package and/or or integrated onto a single device—based on technology, power, space, cost and other tradeoffs. In addition, one or more of the various passive devices such as resistors, capacitors may be integrated into the support chip packages and/or into the substrate, board or raw card itself, based on technology, power, space, cost and other tradeoffs. These packages may also include one or more heat sinks or other cooling enhancements, which may be further attached to the immediate carrier or be part of an integrated heat removal structure that contacts more than one support and/or memory devices.

Memory devices, hubs, buffers, registers, clock devices, passives and other support devices and/or components may be attached as part of the memory modules 206 of FIG. 2 via various methods including solder interconnects, conductive adhesives, socket assemblies, pressure contacts and other methods which enable communication between the two or more devices and/or carriers via electrical, optical or alternate communication means.

The one or more modules, cards and/or alternate subsystem assemblies and/or processing devices 204 may be electrically connected to the processing system 202, processor complex, computer system or other system environment via one or more methods such as soldered interconnects, connectors, pressure contacts, conductive adhesives, optical interconnects and other communication and power delivery methods. Inter-connection systems may include mating connectors (e.g. male/female connectors), conductive contacts and/or pins on one carrier mating with a compatible male or female connection means, optical connections, pressure contacts (often in conjunction with a retaining mechanism) and/or one or more of various other communication and power delivery methods. The interconnection(s) may be disposed along one or more edges of the assembly, may include one or more rows of interconnections and/or be located a distance from an edge of the system depending on such application requirements as the connection structure, the number of interconnections required, performance requirements, ease of insertion/removal, reliability, available space/volume, heat transfer/cooling, component size and shape and other related physical, electrical, optical, visual/physical access, etc. Electrical interconnections on contemporary modules are often referred to as contacts, pins, tabs, etc. Electrical interconnections on a contemporary electrical connector are often referred to as contacts, pads, pins, pads, etc.

Information transfers (e.g. packets) along a bus, channel, link or other interconnection means may be completed using one or more of many signaling options. These signaling options may include one or more of such means as single-ended, differential, optical or other communication methods, with electrical signaling further including such methods as voltage and/or current signaling using either single or multi-level approaches. Signals may also be modulated using such methods as time or frequency, non-return to zero, phase shift keying, amplitude modulation and others. Signal voltage levels are expected to continue to decrease, with 1.5V, 1.2V, 1V and lower signal voltages expected, as a means of reducing power, accommodating reduced technology breakdown voltages, etc.—in conjunction with or separate from the power supply voltages. One or more power supply voltages, e.g. for DRAM memory devices, may drop at a slower rate that the I/O voltage(s) due in part to the technological challenges of storing information in the dynamic memory cells.

One or more clocking methods may be utilized within the processing system 202, including global clocking, source-synchronous clocking, encoded clocking or combinations of these and other methods. The clock signaling may be identical to that of the signal (often referred to as the bus “data”) lines themselves, or may utilize one of the listed or alternate methods that is more conducive to the planned clock frequency(ies), and the number of clocks required for various operations within the system/subsystem(s). A single clock may be associated with all communication to and from the memory, as well as all clocked functions within the system, or multiple clocks may be sourced using one or more methods such as those described earlier. When multiple clocks are used, the functions within the system may be associated with a clock that is uniquely sourced to the system and/or may be based on a clock that is derived from the clock included as part of the information being transferred to and from the system (such as that associated with an encoded clock). Alternately, a unique clock may be used for the information transferred to the system, and a separate clock for information sourced from one (or more) of the systems. The clocks themselves may operate at the same or frequency multiple of the communication or functional frequency, and may be edge-aligned, center-aligned or placed in an alternate timing position relative to the data, command or address information.

The use of bus termination, on busses ranging from point-to-point links to complex multi-drop structures, is becoming more common consistent with increased performance demands. A wide variety of termination methods can be identified and/or considered, and include the use of such devices as resistors, capacitors, inductors or any combination thereof, with these devices connected between the signal line and a power supply voltage or ground, a termination voltage (such voltage directly sourced to the device(s) or indirectly sourced to the device(s) from a voltage divider, regulator or other means), or another signal. The termination device(s) may be part of a passive or active termination structure, and may reside in one or more positions along one or more of the signal lines, and/or as part of the transmitter and/or receiving device(s). The terminator may be selected to match the impedance of the transmission line, be selected as an alternate impedance to maximize the useable frequency, signal swings, data widths, reduce reflections and/or otherwise improve operating margins within the desired cost, space, power and other system/subsystem limits.

Technical effects and benefits include providing dynamic segment sparing and repair in a processing system. Benefits may include improved component yield and dynamically maintenance of functional operation by rerouting defective signals to one or more spare wires or interconnections. The spare interconnections may be unused, redundant or provide additional capacity during normal operation in the absence of any defects, but are not required for functional operation. The ability to replace a failed data segment as well as a failed clock segment increases flexibility in handling a large number of failure modes for interconnected devices.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Moreover, the use of the terms first, second, etc. do not denote any order or importance, but rather the terms first, second, etc. are used to distinguish one element from another.

What is claimed is:

1. A processing device comprising:
drive-side switching logic including driver multiplexers to select driver data for transmitting on link segments of a bus; and
receive-side switching logic including receiver multiplexers to select received data from the link segments of the bus, wherein the bus includes multiple data link segments, a clock link segment, and at least two spare link segments selectable by the drive-side switching logic and the receive-side switching logic to replace one or more of the data link segments and the clock link segment.

2. The processing device of claim 1 wherein the driver multiplexers and the receiver multiplexers are configured upon initialization in response to a pattern transmitted on the bus to detect one or more defective link segments with respect to a second processing device in communication with the processing device via the bus.

3. The processing device of claim 1 wherein one of the driver multiplexers and the receiver multiplexers are configured to switch out a defective link segment upon detecting the defective link segment during a high-speed mode of bus operation, the high-speed mode commencing after completion of initialization of communication between the processing device and a second processing device via the bus.

4. The processing device of claim 1 wherein one of the driver multiplexers and the receiver multiplexers are configured to switch out a defective link segment in response to detecting a communication error via the bus during a high-speed mode of bus operation, the high-speed mode commencing after completion of initialization of communication between the processing device and a second processing device via the bus, and further wherein the initialization is repeated to isolate the defective link segment using a pattern transmitted on the bus.

5. The processing device of claim 1 wherein the processing device is a microprocessor core of a multi-chip module (MCM).

6. The processing device of claim 1 wherein the bus connects the processing device one of: a memory subsystem, or an input/output (I/O) interface.

7. The processing device of claim 1 wherein the driver multiplexers include at least 3 inputs to select the driver data, the receiver multiplexers include at least 3 inputs for selecting the received data, and the clock link segment is selected at the receive-side switching logic prior to clock distribution.

8. The processing device of claim 1 wherein an unused link segment is depowered.

9. A processing system comprising:
a first processing device including drive-side switching logic comprising driver multiplexers to select driver data for transmitting on link segments of a bus; and
a second processing device in communication with the first processing device via the bus, wherein the second processing device includes receive-side switching logic comprising receiver multiplexers to select received data from the link segments of the bus, and further wherein the bus includes multiple data link segments, a clock link segment, and at least two spare link segments selectable by the drive-side switching logic and the receive-side switching logic to replace one or more of the data link segments and the clock link segment.

10. The processing system of claim 9 wherein the driver multiplexers and the receiver multiplexers are configured upon initialization in response to a pattern transmitted on the bus to detect one or more defective link segments.

11. The processing system of claim 9 wherein the driver multiplexers and the receiver multiplexers are configured to switch out a defective link segment upon detecting the defective link segment during a high-speed mode of bus operation, the high-speed mode commencing after completion of initialization of communication between the first and second processing devices.

12. The processing system of claim 9 wherein the driver multiplexers and the receiver multiplexers are configured to switch out a defective link segment in response to detecting a communication error via the bus during a high-speed mode of bus operation, the high-speed mode commencing after completion of initialization of communication between the first processing device and the second processing device via the bus, and further wherein the initialization is repeated to isolate the defective link segment using a pattern transmitted on the bus.

13. The processing system of claim 9 wherein redundant busses interconnect the first processing device with the second processing device.

14. The processing system of claim 9 wherein the first processing device and the second processing device both include the receive-side switching logic and the drive-side switching logic, the drive-side switching logic of the first processing device in communication with the receive-side switching logic of the second processing device, and the drive-side switching logic of the first processing device in communication with the receive-side switching logic of the second processing device.

15. The processing system of claim 9 wherein the first processing device and the second processing device are microprocessor cores of a multi-chip module (MCM).

16. The processing system of claim 9 wherein the driver multiplexers include at least 3 inputs to select the driver data, the receiver multiplexers include at least 3 inputs for selecting the received data, and the clock link segment is selected at the receive-side switching logic prior to clock distribution, and further wherein an unused link segment is depowered.

17. A method for providing a microprocessor interface with dynamic segment sparing and repair, the method comprising:
determining that an error exists on a link segment of a microprocessor interconnect bus between a driver and a receiver in a processing system, wherein the microprocessor interconnect bus includes multiple data link segments, a clock link segment, and at least two spare link segments to communicate memory access commands;
selecting driver data via driver multiplexers at the driver to transmit on selected link segments of the microprocessor interconnect bus, switching out one or more of the data link segments and the clock link segment; and
selecting received data from the microprocessor interconnect bus via receiver multiplexers at the receiver corresponding to the selected link segments.

18. The method of claim 17 wherein the determining that the error exists is performed upon initialization, detecting a defective link segment in response to a pattern transmitted on the microprocessor interconnect bus.

19. The method of claim 17 wherein the determining that the error exists is performed during a high-speed mode of bus operation, the high-speed mode commencing after completion of initialization of communication, and detecting a specific defective link segment is performed during one of: the high-speed mode of bus operation and re-initialization.

20. The method of claim 17 wherein the microprocessor interconnect bus connects a microprocessor to one of: another microprocessor, a memory subsystem, or an input/output (I/O) interface.

21. A design structure tangibly embodied in a machine-readable medium for designing, manufacturing, or testing an integrated circuit, the design structure comprising:
drive-side switching logic including driver multiplexers to select driver data for transmitting on link segments of a microprocessor interconnect bus; and
receive-side switching logic including receiver multiplexers to select received data from the link segments of the microprocessor interconnect bus, wherein the microprocessor interconnect bus includes multiple data link segments, a clock link segment, and at least two spare link segments selectable by the drive-side switching logic and the receive-side switching logic to replace one or more of the data link segments and the clock link segment.

22. The design structure of claim 21, wherein the design structure comprises a netlist.

23. The design structure of claim 21, wherein the design structure resides on storage medium as a data format used for the exchange of layout data of integrated circuits.

24. The design structure of claim 21, wherein the design structure resides in a programmable gate array.
